(19) United States
(12) Patent Application Publication
(10) Pub. No.: US 2015/0070299 A1
(43) Pub. Date: Mar. 12, 2015

(54) TOUCH SENSOR TO RECOGNIZE GESTURE AND METHOD OF CONTROLLING THE SAME

(71) Applicant: SAMSUNG ELECTRO-MECHANICS CO., LTD., Suwon-si (KR)

(72) Inventors: Kyoung Soo CHAE, Suwon-si (KR); Je Ho LEE, Suwon-si (KR); Ho Yun CHO, Suwon-si (KR); Yun Ki HONG, Suwon-si (KR)

(73) Assignee: SAMSUNG ELECTRO-MECHANICS CO., LTD., Suwon-si (KR)

(21) Appl. No.: 14/196,289

(22) Filed: Mar. 4, 2014

(30) Foreign Application Priority Data
Sep. 11, 2013 (KR) 10-2013-0109288

(51) Int. Cl. G06F 3/044; G06F 3/0488

(52) U.S. Cl. CPC G06F 3/044; G06F 3/0488
USPC 345/174

(57) ABSTRACT

Disclosed herein is a touch sensor to recognize a gesture, including: a touch sensor including first electrode patterns and second electrode patterns which are formed on a base substrate in a direction intersection each other, a mode selection unit, a first switching circuit unit, a second switching circuit unit and a control unit detecting a switching operation of the first switching circuit unit and the second switching circuit unit and a change in mutual capacitance in the first electrode pattern group and the second electrode pattern group depending on an operation mode selection of the touch sensor.

### CROSS REFERENCE TO RELATED APPLICATION

This application claims the benefit of Korean Patent Application No. 10-2013-0109288, filed on Sep. 11, 2013, entitled “Touch Sensor To Recognize Gesture And Method Of Controlling The Same”, which is hereby incorporated by reference in its entirety into this application.

### BACKGROUND OF THE INVENTION

1. Technical Field

The present invention relates to a touch sensor to recognize a gesture and a method of controlling the same.

2. Description of the Related Art

With the development of a computer using a digital technology, computer-aided devices have been developing and a personal computer, a portable transmission device, other private information processing devices, and the like have performed text and graphic processing using various input devices, such as a keyboard and a mouse.

However, a technology of the input device has been developing to satisfy high reliability, durability, innovativeness, design, processing related technologies, and the like as well as satisfy general functions. To achieve the purposes, a capacitive type touch panel has been developed as the input devices to input information, such as text and graphic.

Further, a type of a touch sensor is classified into a resistive type, a capacitive type, an electro-magnetic type, a surface acoustic wave type (SAW type), and an infrared type. Various types of capacitive type touch sensors are adopted in electronic products in consideration of a problem of signal amplification, a difference in resolutions, a difficulty in design and processing technologies, optical characteristics, electrical characteristics, mechanical characteristics, environmental-resistance characteristics, input characteristics, durability, and economic efficiency. Today, a type which is most extensively used in applications is the resistive type touch sensor and the capacitive type touch sensor.

Recently, as a high-performance smart phone becomes popular, there is a need to mount various sensor functions (for example, touch sensing, short diameter stylus pen support, proximity sensing, gesture recognition functions, and the like) in the capacitive type touch sensor.

However, the capacitive type touch sensor is different in a structure of a sensor electrode, a driving type, and the like, which are appropriate for various sensor functions as in Patent Document described the following Prior Art Document, such that it may be difficult to integrate the sensor functions in the capacitive type touch sensor.

### PRIOR ART DOCUMENT

### Patent Document

(Patent Document 1) 2011-0057501 KR

### SUMMARY OF THE INVENTION

The present invention has been made in an effort to provide a touch sensor to recognize a gesture capable of operating portable devices without touching the touch sensor by sensing a user's gesture on the touch sensor even in the situations in which it is difficult to provide a touch input as well as in a touch input of the user, and a method of controlling the same.

According to a preferred embodiment of the present invention, there is provided a touch sensor to recognize a gesture, including: a touch sensor including first electrode patterns and second electrode patterns which are formed on a base substrate in a direction intersection each other; a mode selection unit selecting an operation mode of the touch sensor among a touch recognition mode and a gesture recognition mode;

a first switching circuit unit forming a first electrode pattern group configured of at least one of the first electrode patterns by a switching operation and a second switching circuit unit forming a second electrode pattern group configured of at least one of the second electrode patterns by the switching operation, when the gesture recognition mode is selected; and a control unit detecting a switching operation of the first switching circuit unit and the second switching circuit unit and a change in mutual capacitance in the first electrode pattern group and the second electrode pattern group depending on an operation mode selection of the touch sensor.

The first electrode pattern group may include: a first driving electrode group T_{X} applied with a driving signal from the first switching circuit unit; and first sensing electrode groups R_{X} sensing a user's gesture input, and the second electrode pattern group may include: a second driving electrode group T_{X} applied with a driving signal from the second switching circuit unit; and second sensing electrode groups R_{Y} sensing the user's gesture input.

The first driving electrode group T_{X} may be formed at a center of the first electrode pattern and the first sensing electrode groups R_{X} may be formed at both side ends of the first electrode pattern, respectively, and the second driving electrode group T_{Y} may be formed at a center of the second electrode pattern and the second sensing electrode groups R_{Y} may be formed at both side ends of the second electrode pattern, respectively.

The control unit may apply a driving signal to the first driving electrode group T_{X} through the first switching circuit unit and senses a time difference of the change in the mutual capacitance between the first driving electrode group T_{X} and the first sensing electrode groups R_{X} depending on the input of the user's gestures in up and down directions to determine whether the user's gestures in the up and down directions are input, and may apply a driving signal to the second driving electrode group T_{Y} through the second switching circuit unit and sense the time difference of the change in the mutual capacitance between the second driving electrode group T_{Y} and the second sensing electrode groups R_{Y} depending on the input of the user's gestures in left and right directions to determine whether the user's gestures in the left and right directions are input.

The first electrode pattern may be a mesh pattern.

A width of the first electrode pattern may be similar to that of the second electrode pattern.

The touch sensor may include a base substrate, first electrode patterns formed on one surface of the base substrate in parallel with each other, and second electrode patterns formed on a rear surface of the base substrate and formed in parallel with each other in a direction intersecting the first electrode pattern.

When the gesture recognition mode ends, the first switching circuit unit may be electrically connected to all the first electrode patterns by the switching operation, the second switching circuit unit may be electrically connected to all the second electrode patterns by the switching operation, and the control unit may sequentially apply the driving signals to the second electrode patterns through the second switching circuit unit and detect the change in the mutual capacitance sensed in the first electrode patterns.

According to another preferred embodiment of the present invention, there is provided a method of controlling a touch sensor to recognize a gesture, including: selecting a mode which selects whether a touch recognition mode is changed to a gesture recognition mode; performing the gesture recognition mode which senses a time difference of a change in mutual capacitance in first and second electrode pattern groups depending on a user's gesture after the first and second electrode pattern groups are formed when the gesture recognition mode is selected; and determining whether the gesture recognition mode ends depending on whether a specific gesture is input.

In the performing of the gesture recognition mode, the first electrode pattern group configured of at least one of the first electrode patterns may be formed by a switching operation of the first switching circuit unit, and the second electrode pattern group configured of at least one of the second electrode patterns may be formed by a switching operation of the second switching circuit unit.

The first electrode pattern group may include: a first driving electrode group T_{X} applied with a driving signal from the first switching circuit unit; and first sensing electrode groups R_{X} sensing a user's gesture input, and the second electrode pattern group may include: a second driving electrode group T_{Y} applied with a driving signal from the second switching circuit unit; and second sensing electrode groups R_{Y} sensing the user's gesture input.

The first driving electrode group T_{X} may be formed at a center of the first electrode pattern and the first sensing electrode groups R_{X} may be formed at both side ends of the first electrode pattern, respectively, and the second driving electrode group T_{Y} may be formed at a center of the second electrode pattern and the second sensing electrode groups R_{Y} may be formed at both side ends of the second electrode pattern, respectively.

The performing of the gesture recognition mode may include: applying a driving signal to the first driving electrode group T_{X} through the first switching circuit unit and sensing a time difference of the change in the mutual capacitance between the first driving electrode group T_{X} and the first sensing electrode groups R_{X} depending on the input of the user's gestures in up and down directions to determine whether the user's gestures in the up and down directions are input, and applying a driving signal to the second driving electrode group T_{Y} through the second switching circuit unit and sensing the time difference of the change in the mutual capacitance between the second driving electrode group T_{Y} and the second sensing electrode groups R_{Y} depending on the input of the user's gestures in left and right directions to determine whether the user's gestures in the left and right directions are input.

The determining whether the gesture recognition mode ends may include: determining whether a specific gesture to end the gesture recognition mode; releasing grouping of first and second electrode patterns in which the first switching circuit unit is electrically connected to all the first electrode patterns by the switching operation and the second switching circuit unit is connected to all the second electrode patterns by the switching operation, when the gesture input is present; and continuously performing the gesture recognition mode when the gesture input is absent.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a touch sensor to recognize a gesture according to a preferred embodiment of the present invention;

FIG. 2A is a plan view of the touch sensor according to the preferred embodiment of the present invention and FIG. 2B is a cross-sectional view taken along the line A-A′ of FIG. 2A;

FIG. 3 is a diagram illustrating a driving type in a touch recognition mode of the touch sensor to recognize a gesture according to the preferred embodiment of the present invention;

FIG. 4A is a circuit diagram illustrating a grouping type of first electrode patterns in the gesture recognition mode of the touch sensor to recognize a gesture according to the preferred embodiment of the present invention and FIG. 4B is a diagram illustrating a user's sweeping gesture in the up and down directions when the first electrode patterns are grouped;

FIG. 5A is a circuit diagram illustrating a grouping type of second electrode patterns in the gesture recognition mode of the touch sensor to recognize a gesture according to the preferred embodiment of the present invention and FIG. 5B is a diagram illustrating a user's sweeping gesture in the left and right directions when the second electrode patterns are grouped;

FIG. 6 is a diagram illustrating a gesture which ends the gesture recognition mode of the touch sensor to recognize a gesture according to the preferred embodiment of the present invention;

FIG. 7 is a flow chart illustrating a method of controlling a touch sensor to recognize a gesture according to a preferred embodiment of the present invention; and

FIG. 8 is a diagram illustrating a control unit of the touch sensor to recognize a gesture according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

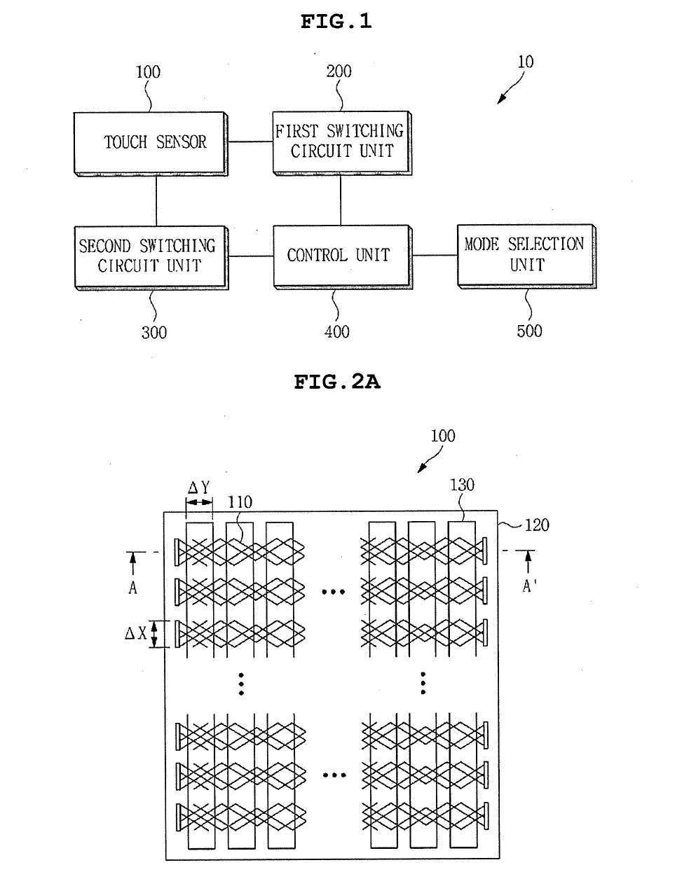

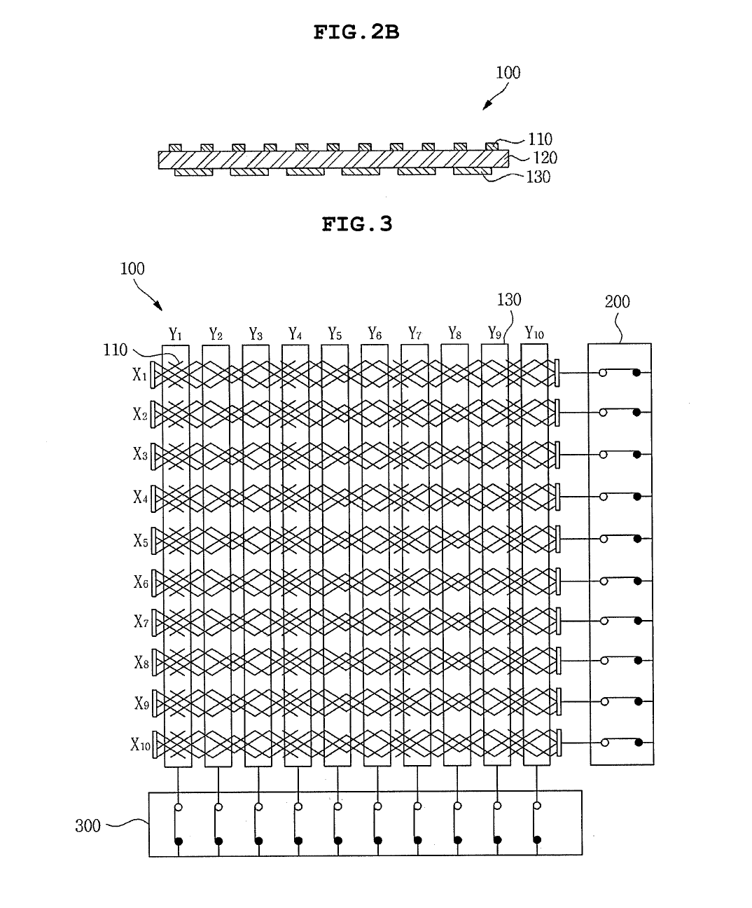

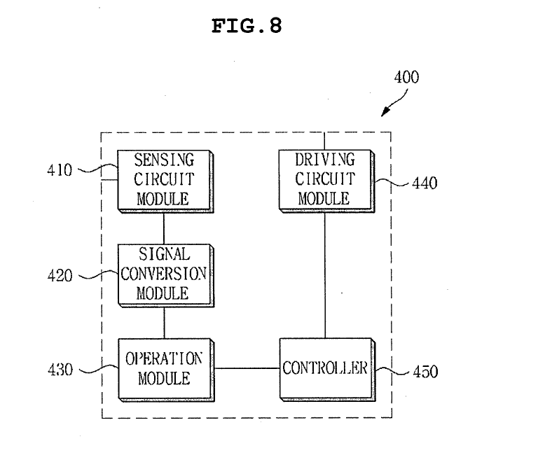

FIG. 1 is a block diagram of a touch sensor to recognize a gesture according to a preferred embodiment of the present invention, FIG. 2A is a plan view of the touch sensor according to the preferred embodiment of the present invention and FIG. 2B is a cross-sectional view taken along the line A-A′ of FIG. 2A, and FIG. 8 is a diagram illustrating a control unit of the touch sensor.

As illustrated in FIGS. 1 and 8, the touch sensor to recognize a gesture according to the preferred embodiment of the present invention includes a first switching circuit unit, a second switching circuit unit, a control unit, and a mode selection unit, in which the control unit includes a sensing circuit module, a signal conversion module, an operation module, a driving circuit module, and a controller.

As illustrated in FIGS. 2A and 2B, the touch sensor 100 includes a base substrate 120, first electrode patterns 110 formed on one surface of the base substrate 120 and formed in parallel with each other in one direction, and second electrode patterns 130 formed on a rear surface of the substrate 120 and formed in parallel with each other in a direction intersecting the first electrode patterns 110.

In this configuration, the base substrate 120 serves to provide a region in which electrode patterns, electrode wirings, and the like are formed and is made of any material having transparency and predetermined strength without being particularly limited, but is preferably made of polyethylene terephthalate (PET), polycarbonate (PC), polymethyl methacrylate (PMMA), glass, tempered glass, or the like.

Meanwhile, the first electrode pattern 110 may be formed in a mesh pattern using copper (Cu), aluminum (Al), gold (Au), silver (Ag), titanium (Ti), palladium (Pd), chromium (Cr), or a combination thereof and the second electrode pattern 130 may be formed in a bar electrode structure having a mesh pattern or a solid form.

Further, in the case of the mutual-capacitance touch sensor according to the prior art, the first electrode pattern (upper electrode pattern) 110 is formed to have a relatively narrower width than that of the second electrode pattern (lower electrode pattern) 130 based on a resistance limit so as not to block a coupling due to an electric field with the second electrode pattern (lower electrode pattern) 130 and a touch input unit, but when the first electrode pattern is formed in a metal mesh pattern having a wider width, an SNR to recognize a touch and a gesture may be obtained.

That is, when the first electrode pattern 110 is formed in the metal mesh pattern, since the first electrode pattern 110 does not block the coupling with touch input unit due to the electric field, the SNR to recognize the touch and the gesture may be obtained independent of the formation structure (bar electrode structure having a mesh pattern or a solid form) of the second electrode pattern, even though the width of the first electrode pattern is the same as or similar to that of the second electrode pattern.

A mode selection unit 500 serves to select an operation mode of the touch sensor among a touch recognition mode and a gesture recognition mode according to a user selection and may be configured of an H/W or S/W button.

First and second switching circuit units 200 and 300 are electrically connected to first and second electrode patterns X1 to X10 and Y1 to Y10 110 and 130 depending on an operation mode selection of the touch sensor 100.

That is, a control unit 400 controls a switching operation of the first switching circuit unit 200 and the second switching circuit unit 300 and a driving signal applied to the first electrode patterns X1 to X10 and the second electrode patterns Y1 to Y10 and detects a change in mutual capacitance sensed in the first electrode pattern 110 and the second electrode pattern 130.

In this configuration, the control unit 400 includes a sensing circuit module 410, a signal conversion module 420, an operation module 430, a driving circuit module 440, and a controller 450. The sensing circuit module 410 is connected to the second switching circuit unit 300 and detects the change in the mutual capacitance in the touch sensor 100 and generates an analog signal (voltage form) corresponding to the sensed change, the signal conversion module 420 is connected to the sensing circuit module 410 and converts the analog signal (voltage form) into a digital signal, the signal conversion type may be a time-to-digital converter (TDC) type which measures the time when the analog signal reaches a predetermined reference voltage level and converts the measured time into a digital signal or an analog-to-digital converter (ADC) type which measures an amount in which a level of the analog signal is changed for a predetermined time and converts the measured change amount into a digital signal. Further, the operation module 430 uses the digital signal to determine the number, coordinates, gesture operation, or the like of touch inputs applied to the touch sensor and the driving circuit module is connected to the first switching circuit unit and applies a predetermined driving signal to the touch sensor.

Further, the controller 450 controls operations of the sensing circuit module 410, the signal conversion module 420, the operation module 430, the driving circuit module 440, and the first and second switching circuit units. Herein, the controller 450 may be a micro controller unit (MCU).

Hereinafter, the driving type of the touch sensor to recognize the gesture depending on the operation mode section of the touch sensor will be described in more detail.

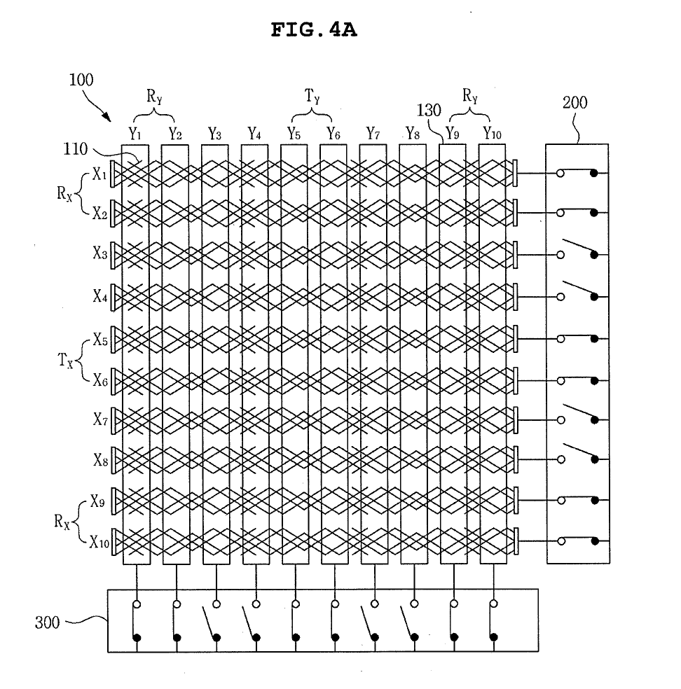

FIG. 3 is a circuit diagram illustrating a driving type in the touch recognition mode of the touch sensor to recognize a gesture according to the preferred embodiment of the present invention.

When the touch recognition mode is selected in the mode selection unit by the user, the controller 450 controls the switching operation of the first and second switching circuit units 200 and 300 to perform a control to electrically connect the first and second switching circuit units to both of the first and second electrode patterns 110 and 130.

Further, the driving circuit module 44Q sequentially applies the driving signals to the second electrode patterns 130 through the second switching circuit unit 300 and the sensing circuit module 410 detects the change in the mutual capacitance sensed in each of the first electrode patterns 110 depending on the touch input of the user to discriminate the coordinates of the touched position at which the mutual capacitance is changed, by the operation module 430.

That is, after the sensing circuit module 410 converts mutual capacitance values sensed in the first electrode patterns 110 into voltage values and then sets the voltage values to a base line, the driving circuit module sequentially applies the driving signals to the second electrode patterns 130 and then the sensing circuit module 410 repeatedly performs a process of detecting the mutual capacitance in the first electrode pattern 110 to update the base line.

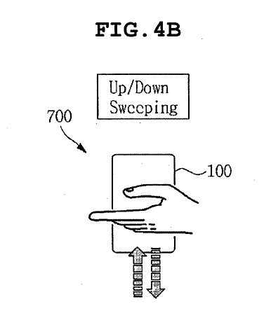

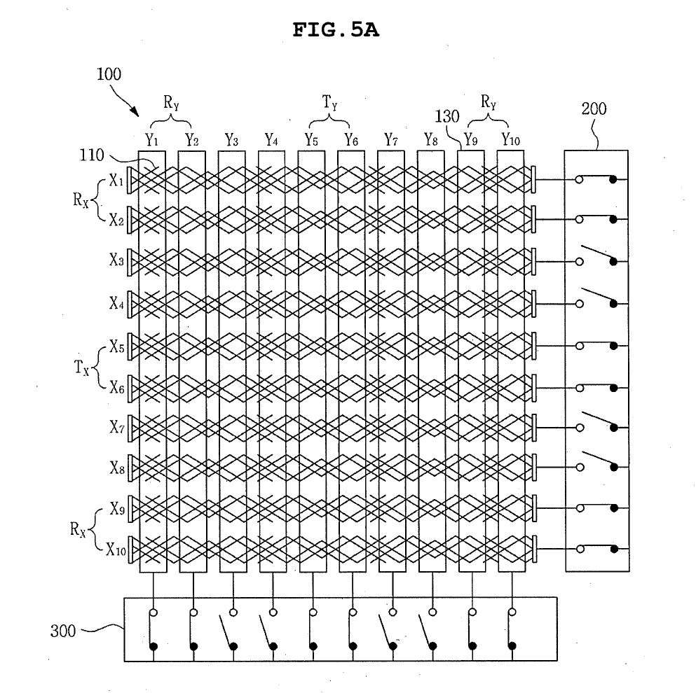

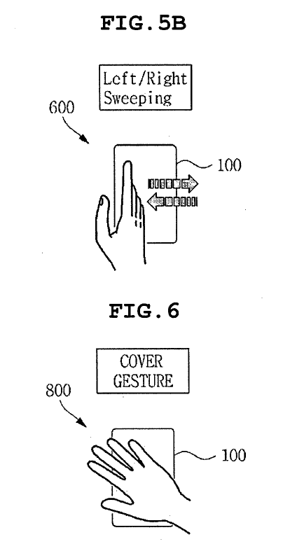

FIGS. 4A and 5A are circuit diagrams illustrating a grouping type of the first and second electrode patterns in the gesture recognition mode of the touch sensor to recognize a gesture according to the preferred embodiment of the present invention, FIGS. 4B and 5B are diagrams illustrating user's sweeping gestures in the up and down directions and the left and right directions after the first and second electrode patterns are grouped, and FIG. 6 is a diagram illustrating a gesture to end the gesture recognition mode.

As illustrated in FIGS. 4A to 5B, when the gesture recognition mode is selected in the mode selection unit 500 by the user, the control unit 400 controls the switching operation of the first switching circuit unit 200 to form first electrode pattern groups T_{X} and R_{X} configured of at least one first electrode pattern 110 and then controls the switching operation of the second switching circuit unit 300 to form second electrode pattern groups T_{Y} and R_{Y} configured of at least one second electrode pattern 130.

That is, the first electrode pattern group includes the first driving electrode group T_{X} applied with the driving signal from the first switching circuit unit and the first sensing electrode group R_{X} sensing the user's gesture input and the second electrode pattern group includes the second driving electrode group T_{Y} applied with the driving signal from the second switching circuit unit and the second sensing electrode group R_{Y} sensing the user's gesture input.

Here, the first driving electrode group T_{X} may be formed at a center of the first electrode pattern and the first sensing electrode groups R_{X} may be formed at both side ends of the first electrode pattern, respectively, and the second driving electrode group T_{Y} is formed at a center of the second electrode pattern and the second sensing electrode groups R_{Y} may be formed at both side ends of the second electrode pattern, respectively.

Further, for the gesture input of the user's gesture inputs in the up and down directions, the first driving electrode group T_{X} is applied with the driving signal from the driving circuit module 440 through the first switching circuit unit 200, the sensing circuit module senses a time difference of the change in the mutual capacitance between the first driving electrode group T_{X} and the first sensing electrode group R_{X} and then generates the analog signal (voltage) corresponding to the change in the mutual capacitance, and the controller 450 determines whether the user's gestures 700 in the up and down directions are input based on results calculated by the signal conversion module 420 and the operation module 430.

Further, for the gesture input of the user's gesture inputs in the left and right directions, the second driving electrode group T_{Y} is applied with the driving signal from the driving circuit module 440 through the second switching circuit unit 300, the sensing circuit module 410 senses a time difference of the change in the mutual capacitance between the second driving electrode group T_{Y} and the second sensing electrode group R_{Y} and then generates the analog signal (voltage) corresponding to the change in the mutual capacitance, and the controller 450 determines whether the user's gestures 600 in the left and right directions are input based on the results calculated by the signal conversion module 420 and the operation module 430.

That is, it is possible to sense whether the user's gesture is input and the input direction of the gesture, by sensing the change in the mutual capacitance between the first driving electrode group T_{X} of the first electrode pattern and the first sensing electrode group R_{X} of the upper side portion when the user's gesture is input downwardly from above and sensing the change in the mutual capacitance between the second driving electrode group T_{Y} of the second electrode pattern and the second sensing electrode group R_{Y} of the left side portion when the user's gesture is input from the left to the right.

Further, as illustrated in FIG. 6, when a cover operation covering the touch sensor with the user's gesture is sensed, the control unit 400 recognizes the cover operation as a gesture to end the gesture recognition mode and the controls the switching operation of the first and second switching circuit units 200 and 300 to electrically connect the switches of the first and second switching circuit units 200 and 300 to both of the first and second electrode patterns 110 and 130, thereby releasing the first and second electrode pattern groups T_{X}, R_{X}, T_{Y}, and R_{Y}. Herein, the gesture to end the gesture recognition mode is not limited to the cover operation.

As set forth above, it is possible to increase the efficiency of the manufacturing process and the overall productivity by making the multi-functional touch sensor light, thin, short, and small without adding the components to recognize the gesture, by integrating the touch and gesture recognition functions in the electrode pattern based on the grouping of the electrode patterns using the electrode patterns of the mutual-capacitive type touch sensor according to the prior art by the switching operation of the first and second switching circuit units.

Further, it is possible to control the portable devices, the contents, or the like, by determining whether the user's gesture is input by detecting the time difference in the mutual-capacitance change due to the user's gestures in the up and down directions or the left and right directions even in the situations in which it is difficult to provide the touch input from the outside and only by the touch input and the gesture by performing the function corresponding to the gesture input.

In addition, it is possible to secure the signal to noise ratio (SNR) which may be used to recognize both of the touch and gesture, by forming the first electrode pattern of the touch sensor in the metal mesh pattern so that the width of the first electrode pattern is larger, as compared with the existing mutual-capacitance type.

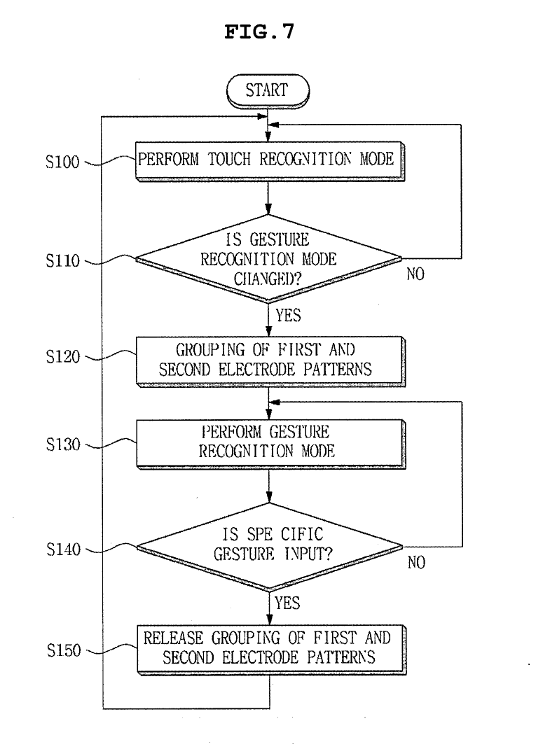

FIG. 7 is a flow chart illustrating a method of controlling a touch sensor to recognize a gesture according to a preferred embodiment of the present invention. As illustrated in FIG. 7, the method of controlling a touch sensor to recognize a gesture includes performing the touch recognition mode (S100), selecting the mode (S110), performing the gesture recognition mode (S120 and S130), and determining whether the gesture recognition mode ends.

First, in the performing of the touch recognition (S100), the driving circuit module 440 sequentially applies the driving signals to the second electrode patterns 130 through the second switching circuit unit 300 and the sensing circuit module 410 detects the change in the mutual capacitance sensed in each of the first electrode patterns 110 depending on the touch input of the user to discriminate the coordinates of the touched position at which the mutual capacitance is changed, by the operation module 430.

Next, in the selecting of the mode (S110), the user selects whether the touch recognition mode is changed to the gesture recognition mode by the mode selection unit 500 and continuously performs the touch recognition mode when the gesture recognition mode is not selected (S100).

Further, when the user selects the gesture recognition mode, the control unit 400 performs the gesture recognition mode which forms the first and second electrode pattern groups T_{X}, R_{X}, T_{Y}, and R_{Y} configured of the at least one of the first and second electrode patterns 110 and 130 by the switching operation of the first and second switching circuit units 200 and 300 (S120) and then detects the time difference of the change in the mutual capacitance of the first and second electrode pattern groups T_{X}, R_{X}, T_{Y}, and R_{Y} depending on the user's gesture (S130).

Herein, the control unit 400 sequentially applies the driving signals to the first and second driving electrode groups T_{X} and T_{Y} through the first and second switching circuit units 200 and 300 and detects the time difference in the mutual capacitance between the first driving electrode group T_{Y} and the first sensing electrode group R_{X} and between the second driving electrode group T_{Y} and the second sensing electrode group R_{Y} to determine the motion direction of the user's gesture (up<->down direction or left<->right direction).

Further, the control unit 400 determines whether the specific user's gesture is input and thus determines whether the gesture recognition mode ends (S140). That is, as illustrated in FIG. 6, when the user inputs the cover gesture covering the touch sensor, the control unit 400 recognizes the gesture as ending the gesture recognition mode.

Next, when the specific user's gesture is input, the control unit 400 controls the switching operation of the first and second switching circuit units 200 and 300 to electrically connect the first and second switching circuit units 200 and 300 to all the first and second electrode patterns 110 and 130, thereby releasing the first and second electrode pattern grouping (S150) and continuously performs the gesture recognition mode when the specific user's gesture is not input.

According to the preferred embodiments of the present invention, it is possible to increase the efficiency of the manufacturing process and the overall productivity by making the multi-functional touch sensor light, thin, short, and small without adding the components to recognize the gesture, by integrating the touch and gesture recognition functions in the electrode pattern based on the grouping of the electrode patterns using the electrode patterns of the mutual-capacitive type touch sensor according to the prior art by the switching operation of the first and second switching circuit units.

Further, it is possible to control the portable devices, the contents, or the like, by determining whether the user's gesture is input by detecting the time difference in the mutual-capacitance change due to the user's gestures in the up and down directions or the left and right directions even in the situations in which it is difficult to provide the touch input from the outside and only by the touch input and the gesture by performing the function corresponding to the gesture input.

In addition, it is possible to secure the signal to noise ratio (SNR) which may be used to recognize both of the touch and gesture, by forming the first electrode pattern of the touch sensor in the metal mesh pattern so that the width of the first electrode pattern is larger, as compared with the existing mutual-capacitance type.

Moreover, it is possible to sense whether the user's gesture is input and the input direction of the gesture, by sensing the change in the mutual capacitance between the first driving electrode group T_{X} of the first electrode pattern and the first sensing electrode group R_{X} of the upper side portion when the user's gesture is input downwardly from above and sensing the change in the mutual capacitance between the second driving electrode group T_{Y} of the second electrode pattern and the second sensing electrode group R_{Y} of the left side portion when the user's gesture is input from the left to the right.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch sensor to recognize a gesture, comprising:
a touch sensor including first electrode patterns and second electrode patterns which are formed on a base substrate in a direction intersecting each other;
a mode selection unit selecting an operation mode of the touch sensor among a touch recognition mode and a gesture recognition mode;
a first switching circuit unit forming a first electrode pattern group configured of at least one of the first electrode patterns by a switching operation and a second switching circuit unit forming a second electrode pattern group configured of at least one of the second electrode patterns by the switching operation, when the gesture recognition mode is selected; and
a control unit detecting a switching operation of the first switching circuit unit and the second switching circuit unit and a change in mutual capacitance in the first electrode pattern group and the second electrode pattern group depending on an operation mode selection of the touch sensor.

2. The touch sensor as set forth in claim 1, wherein the first electrode pattern group includes:
a first driving electrode group T_{X} applied with a driving signal from the first switching circuit unit; and
first sensing electrode groups R_{X} sensing a user's gesture input, and
the second electrode pattern group includes:
a second driving electrode group T_{Y} applied with a driving signal from the second switching circuit unit; and
second sensing electrode groups R_{Y} sensing the user's gesture input.

3. The touch sensor as set forth in claim 2, wherein the first driving electrode group T_{X} is formed at a center of the first electrode pattern and the first sensing electrode groups R_{X} are formed at both side ends of the first electrode pattern, respectively, and
the second driving electrode group T_{Y} is formed at a center of the second electrode pattern and the second sensing electrode groups R_{Y} are formed at both side ends of the second electrode pattern, respectively.

4. The touch sensor as set forth in claim 1, wherein the control unit applies a driving signal to the first driving electrode group T_{X} through the first switching circuit unit and senses a time difference of the change in the mutual capacitance between the first driving electrode group T_{X} and the first sensing electrode groups R_{X} depending on the input of the user's gestures in up and down directions to determine whether the user's gestures in the up and down directions are input, and
applies a driving signal to the second driving electrode group T_{Y} through the second switching circuit unit and senses the time difference of the change in the mutual capacitance between the second driving electrode group T_{Y} and the second sensing electrode groups R_{Y} depending on the input of the user's gestures in left and right directions to determine whether the user's gestures in the left and right directions are input.

5. The touch sensor as set forth in claim 1, wherein the first electrode pattern is a mesh pattern.

6. The touch sensor as set forth in claim 5, wherein a width of the first electrode pattern is similar to that of the second electrode pattern.

7. The touch sensor as set forth in claim 1, wherein the touch sensor includes a base substrate, first electrode patterns formed on one surface of the base substrate in parallel with each other, and second electrode patterns formed on a rear surface of the base substrate and formed in parallel with each other in a direction intersecting the first electrode pattern.

8. The touch sensor as set forth in claim 1, wherein when the gesture recognition mode ends,
the first switching circuit unit is electrically connected to all the first electrode patterns by the switching operation,
the second switching circuit unit is electrically connected to all the second electrode patterns by the switching operation, and
the control unit sequentially applies the driving signals to the second electrode patterns through the second switching circuit unit and detects the change in the mutual capacitance sensed in the first electrode patterns.

9. A method of controlling a touch sensor to recognize a gesture, comprising:
selecting a mode which selects whether a touch recognition mode is changed to a gesture recognition mode;
performing the gesture recognition mode which senses a time difference of a change in mutual capacitance in first and second electrode pattern groups depending on a user's gesture after the first and second electrode pattern groups are formed when the gesture recognition mode is selected; and
determining whether the gesture recognition mode ends depending on whether a specific gesture is input.

10. The method as set forth in claim 9, wherein in the performing of the gesture recognition mode, the first electrode pattern group configured of at least one of the first electrode patterns is formed by a switching operation of the first switching circuit unit, and
the second electrode pattern group configured of at least one of the second electrode patterns is formed by a switching operation of the second switching circuit unit.

11. The method as set forth in claim 10, wherein the first electrode pattern group includes:
a first driving electrode group T_{X} applied with a driving signal from the first switching circuit unit; and
first sensing electrode groups R_{X} sensing a user's gesture input, and
the second electrode pattern group includes:
a second driving electrode group T_{Y} applied with a driving signal from the second switching circuit unit; and
second sensing electrode groups R_{Y} sensing the user's gesture input.

12. The method as set forth in claim 11, wherein the first driving electrode group T_{X} is formed at a center of the first electrode pattern and the first sensing electrode groups R_{X} are formed at both side ends of the first electrode pattern, respectively, and
the second driving electrode group T_{Y} is formed at a center of the second electrode pattern and the second sensing electrode groups R_{Y} are formed at both side ends of the second electrode pattern, respectively.

13. The method as set forth in claim 12, wherein the performing of the gesture recognition mode includes:
applying a driving signal to the first driving electrode group T_{X} through the first switching circuit unit and sensing a time difference of the change in the mutual capacitance between the first driving electrode group T_{X} and the first sensing electrode groups R_{X} depending on the input of the user's gestures in up and down directions to determine whether the user's gestures in the up and down directions are input, and
applying a driving signal to the second driving electrode group T_{Y} through the second switching circuit unit and sensing the time difference of the change in the mutual capacitance between the second driving electrode group T_{Y} and the second sensing electrode groups R_{Y} depending on the input of the user's gestures in left and right directions to determine whether the user's gestures in the left and right directions are input.

14. The method as set forth in claim 9, wherein the determining whether the gesture recognition mode ends includes:
determining whether a specific gesture to end the gesture recognition mode;
releasing grouping of first and second electrode patterns in which the first switching circuit unit is electrically connected to all the first electrode patterns by the switching operation and the second switching circuit unit is connected to all the second electrode patterns by the switching operation, when the gesture input is present; and
continuously performing the gesture recognition mode when the gesture input is absent.
